(19) United States
(12) Patent Application Publication
(10) Pub. No.: US 2005/0145761 A1
(43) Pub. Date: Jul. 7, 2005

(54) Post assembly

(75) Inventor: Donald W. Wooten, Dallas, TX (US)

Correspondence Address: DUNLAP, CODDING & ROGERS P.C., PO BOX 16370, OKLAHOMA CITY, OK, 73113, US

(73) Assignee: Tactical and Rescue Equipment LLC

(21) Appl. No.: 11/030,342

(22) Filed: Jan. 6, 2005

Related U.S. Application Data
(60) Provisional application No. 60/534,421, filed on Jan. 6, 2004.

(51) Int. Cl. G11B 5/027

(52) U.S. Cl. 248/156

(57) ABSTRACT

A post assembly, comprising a post and a driving device. The post has a first end and a second end. The driving device has a first end, a second end, and a driving member wherein the driving device is removably attached to the post in a driving position for applying force to the driving member thereby driving the post in a downward direction into the ground.

### CROSS REFERENCE TO RELATED APPLICATIONS

This application claims the benefit under 35 U.S.C. 119(e) of U.S. Provisional Application Ser. No. 60/534,421, filed Jan. 6, 2004, the contents of which are hereby expressly incorporated by reference herein in its entirety.

### STATEMENT REGARDING FEDERALLY SPONSORED RESEARCH OR DEVELOPMENT

Not Applicable.

### BRIEF DESCRIPTION OF THE SEVERAL VIEWS OF THE DRAWINGS

FIG. 1 is a perspective view of a post assembly constructed in accordance with the present invention.

FIG. 2 is a perspective view of a plurality of posts connected together.

FIG. 3 is an enlarged perspective view of a portion of FIG. 2 illustrating the interconnection of two posts.

FIG. 4 is a perspective view of a driving device of the post assembly.

FIG. 5 is a perspective view of the post assembly in a driving position.

FIG. 6 is a perspective view of the driving device of the post assembly in a stowed position.

FIG. 7 is a perspective view of the post assembly in a stabilizing position.

FIG. 8 is a perspective view of a clip attached to a post.

FIG. 9 is another perspective view of the clip in FIG. 8 attached to the post.

FIG. 10 is a perspective view of a plurality of posts in an open position.

FIG. 11 is a perspective view of the plurality of posts in FIG. 10 in a closed position.

### DETAILED DESCRIPTION OF THE INVENTION

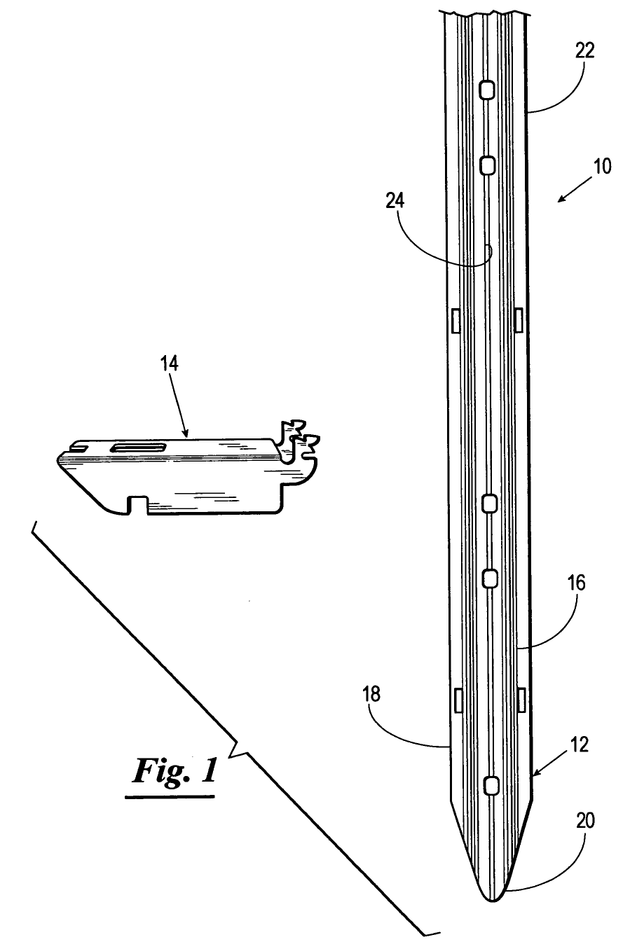

Referring now to the drawings and in particular to FIG. 1, shown therein and designated by a reference numeral 10 is a post assembly constructed in accordance with the present invention. The post assembly 10 is provided with a post 12 and a driving device 14.

The post assembly 10 offers the primary advantage of being strong and easily storable. The post assembly 10 is typically constructed to be used in desert or arctic environments where the ground shifts, however, the post assembly 10 can be adapted to function in any terrain.

The post 12 can be constructed from steel, aluminum, glass-reinforced polymer or any other rigid material and can be produced at various lengths. Preferably the post 12 will be constructed at a length of at least six feet.

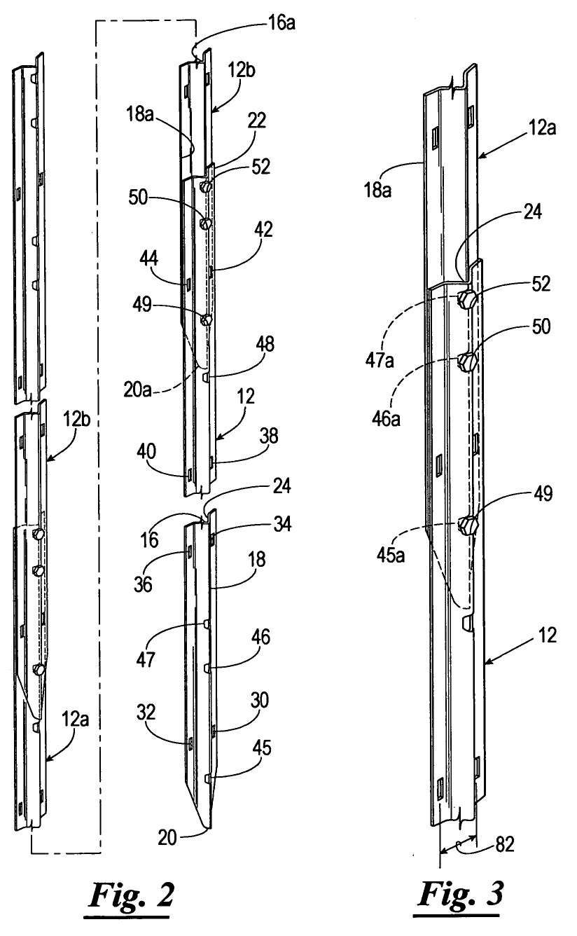

The post 12 is an elongated structure having a first side 16, a second side 18, a first end 20 and a second end 22. The first side 16 has a substantially v-shaped channel 24 extending from the first end 20 to the second end 22. The second side 18 is complementary to the first side 16. The channel 24 is sized and adapted to receive a second side 18a of another post 12a identical to post 12, as shown in FIGS. 2 and 3.

The first end 20 is shown as being substantially pointed so as to enable the post 12 to be more easily driven into the ground. However, it should be understood that the first end 20 may also have jagged teeth for cutting into harder more mountainous terrain and may have any other shaped end adapted to be used in other terrains.

The post 12 is provided with pairs of spatially disposed holes 30 and 32, 34 and 36, 38 and 40, and 42 and 44 extending from the first end 20 to the second end 22. The spatially disposed holes 30 and 32, 34 and 36, 38 and 40, and 42 and 44 are positioned along the post 12 so as to be in a convenient driving location as the post 12 is driven into the ground. Connection openings 45, 46, 47, 48, 49, 50, and 52 are centrally located on the post 12 allowing for the vertical connection of post 12a to post 12 as shown in FIGS. 2 and 3. The second side 18a of post 12a is positioned within the channel 24 of post 12 so that the connection openings 49, 50 and 52, located on the second end 22 of post 12, can be aligned with connection openings 45a, 46a, and 47a located on a first end 20a of post 12a to be connected to the post 12 after or before the first end 20 of post 12 is driven into the ground. Posts 12 and 12a are shown connected with a bolt. However, posts 12 and 12a can be connected by clamps, straps, ratchet teeth, or any other method for connecting the posts 12 and 12a. A plurality of identical posts can be connected in an identical manner for forming fence, walls, signposts, etc. Any number of posts can be connected together as shown in FIG. 2, by posts 12, 12a, and 12b.

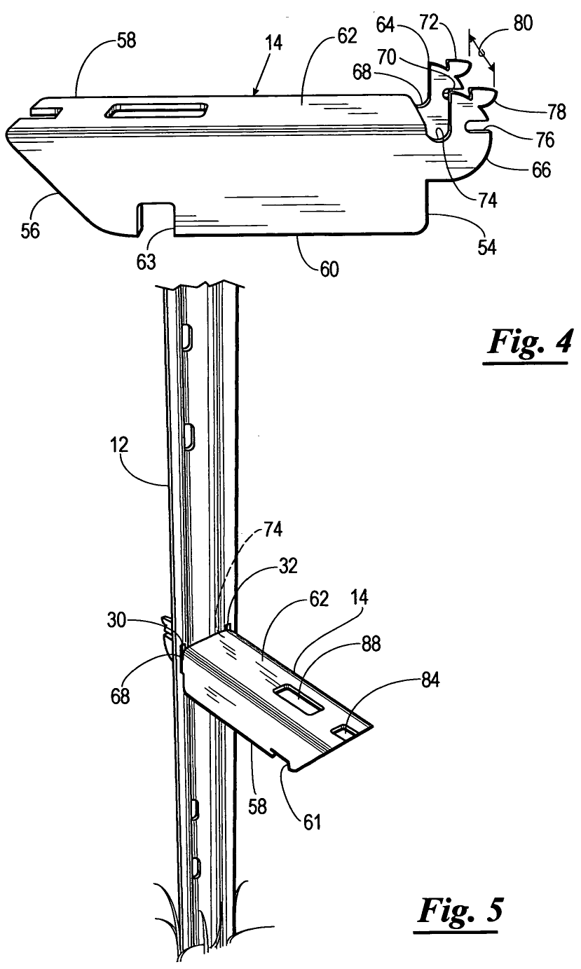

Referring to FIG. 4, the driving device 14 has a first end 54, a second end 56, a first side 58, a second side 60, and a driving member 62. The first end 54 is provided with a pair of ears 64 and 66 which function to attach the driving device 14 to the post 12. The first side 58 is shown provided with a cutout shaped like a bottle opener 61 (FIG. 5) and the second side 60 is provided with a square shaped cutout 63 which is used as a wrench.

The first ear 64 is positioned on the first side 58 of the driving device 14 so as to extend past the driving member 62. The first ear 64 is provided with a first groove 68, a first slot 70, and a first tab 72. The second ear 66 is positioned on the second side 60 of the driving device 14 so as to extend past the driving member 62. The second ear 66 is provided with a second groove 74, a second slot 76, and a second tab 78. The distance 80 between the first and second ears 64 and 66 is substantially the same as the distance 82 (FIG. 3) between the pair of spatially disposed holes 30 and 32, 34 and 36, and 38 and 40 positioned on the post 12 so that the first ear 64 can be disposed within the holes 30, 34, and 38 and the second ear 66 can be disposed within the holes 32, 36, and 40 for connecting the driving device 14 to the post 12.

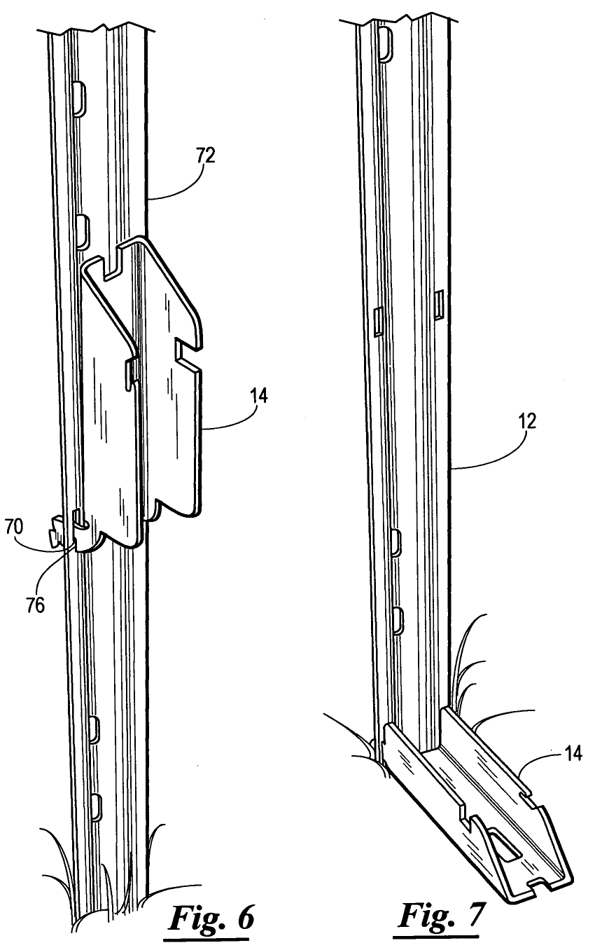

The first and second grooves 68 and 74 are used to lock the driving device 14 into the pair of holes 30 and 32 of the post 12 in the driving position as shown in FIG. 5. The first and second slots 70 and 76 are used to hold the driving device 14 to the post 12 in a stowed position when the driving device 14 is not being used as shown in FIG. 6. The first and second slots 70 and 76 are also used as a wrench for bending the second and first tabs, 78 and 72, respectively, to hold the driving device vertical and prevent the driving device 14 from coming out of the post 12.

As shown in FIG. 5, the driving member 62 is provided with a square shaped cutout 84 which is used as a socket wrench. The driving member 62 is also provided with a cutout 86 which receives a stake for stabilizing the post 12. The stake can be constructed of any rigid material, such as wood, steel, or plastic. The cutout 86 can be any suitable shape, such as square or circular.

The driving member 62 is used as a platform for driving the post 12 into the ground. When the driving device 14 is attached to the post 12 in the driving position as shown in FIG. 5, an individual applies force with a foot, a hand, or a tool on the driving member 62 so as to drive the post 12 in a first direction, such as downwardly into the ground. Once the post 12 is driven into the ground such that the driving device 14 contacts the ground, the driving device 14 can be positioned in openings 34 and 36 that are farther from the ground by detaching the driving device 14 from openings 30 and 32 of the post 12 and then applying force again as discussed above. Once the post 12 is driven into the ground such that the driving device 14 contacts the ground again, the driving device 14 can be ratcheted up the post 12 to openings 38 and 40 to continue sequentially driving the post 12 deeper into the ground.

The driving device 14 can then be turned over to prevent the post 12 from going any further into the ground, as shown in FIG. 7. Plywood, a sheet of metal, a board, or some other such material can be placed between the driving device 14 and the ground to provide additional stability.

The driving device 14 is removably connected to the post 12 so that a single driving device 14 can be used with a plurality of posts. This is particularly useful in desert environments due to the softness of the sand. Posts must be driven deep in the sand to provide stability.

In use, a first post 12 is manually or machine driven into the sand with the driving device 14. A second post 12a is connected to the first post 12. The driving device 14 is removed from the first post 12 and attached to the second post 12a. The second post 12a is then driven down into the sand, thus further driving the first post 12 into the sand. This process continues with as many posts as needed until the desired stability has been reached.

The post assembly 10 also allows an individual to drive posts in the ground more safely and without damage to the post. For example, one common prior method used in driving posts consists of an individual engaging the top of the post to be driven downward. One of the problems with this method of driving is that a large amount of force is needed to push the post into the ground. If a six foot or longer post is being used, most individuals will be required to raise a heavy tool over the head or stand on a lift or ladder when driving down the tool on the post. Not only does this method risk damage to the post from bending, but it also risks damage to the individual's head, arms, back and legs.

The post assembly 10 can be used by the military as a fast method of marking a minefield after the minefield has been cleared. The post assembly 10 can also be used to mark a narrow path through the minefield. Signs or lights can be placed on the post assembly 10 to direct motorized vehicles or infantry.

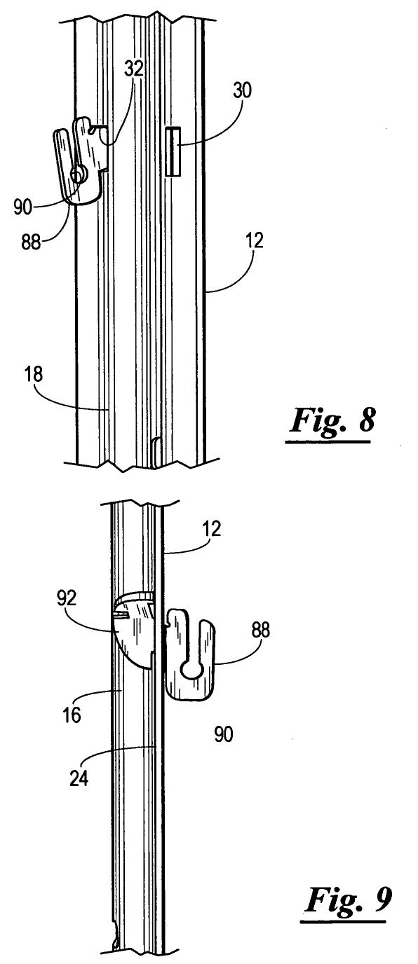

Barbed wire or any other type of wire or rope can be used in association with a number of the assembly posts 10 to create a fence or secure area. A clip 88, as shown in FIGS. 8 and 9, is provided having an elongated opening 90 for holding barbed wire. The clip 88 can be disposed in any of the holes 30, 32, 34, 36, 38, 40, 42, and 44 of the post assembly 10. The clip 88 is also provided with a tab member 92 which is positioned in the v-shaped channel 24 which prevents the clip 88 from coming out of the post 12.

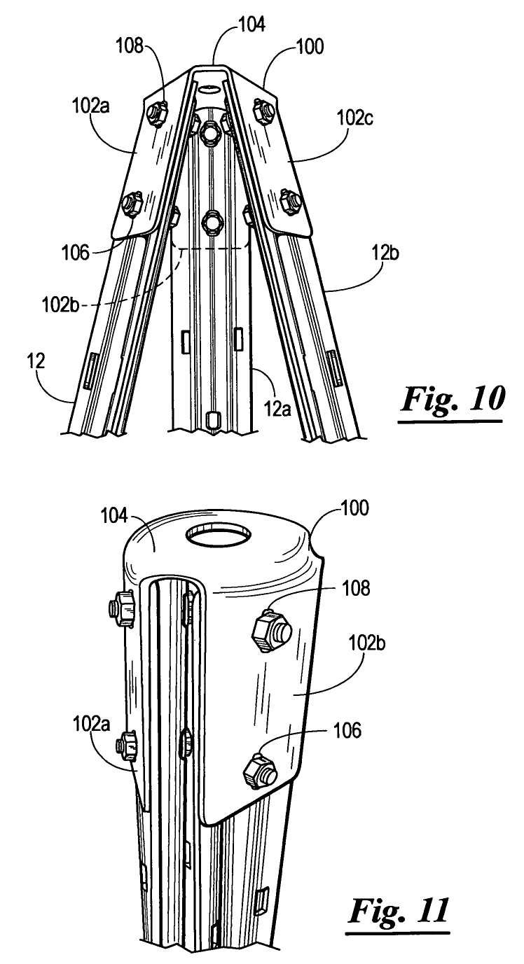

Referring to FIGS. 10 and 11, a plurality of posts 12, 12a, and 12b are positioned in a tripod configuration for marking minefields and other uses. The posts 12, 12a, and 12b are connected to a cap 100. The cap 100 has at least one and preferably a plurality of legs 102 (labeled in FIGS. 10 and 11 via the reference numerals 102a, 102b, and 102c for purposes of clarity) connected to and extending from a connecting member 104. Each of the legs 102 are provided with an attachment assembly 105 for attaching the cap 100 to the posts 12, 12a, and 12b. For example, in one embodiment a pair of openings 106 and 108 are formed in and centrally located on the leg 102 allowing for the vertical connection of posts 12, 12a, and 12b. The posts 12, 12a, and 12b are shown connected with bolts. However, posts 12, 12a, and 12b can be connected to the cap 100 by clamps, straps, ratchet teeth, or any other method for connecting posts 12, 12a, and 12b to the cap 100. The connecting member 104 connects each of the legs 102 such that the legs 102 are selectively moveable from the connecting member 104 between the open position, as shown in FIG. 10, and the closed position, as shown in FIG. 11.

Changes may be made in the combinations, operations, and arrangements of the various parts and elements described herein without departing from the spirit and the scope of the invention as defined in the following claims.

1. A post assembly, comprising:
a post having a first end and a second end; and
a driving device having a first end, a second end, and a driving member wherein the driving device is removably attached to the post in a driving position for applying force to the driving member thereby driving the post in a downward direction into the ground.

2. The post assembly of claim 1 wherein the post is provided with a plurality of pairs of spatially disposed holes positioned along the post for removable attachment to the driving device.

3. The post assembly of claim 2 wherein the driving device is provided with a pair of ears which removably attach the driving device to the post by being positioned within at least one of the plurality of pairs of spatially disposed holes.

4. The post assembly of claim 3 wherein each of the ears is provided with a groove which is used to place the driving device in a locked position.

5. The post assembly of claim 1 wherein the first end of the post is substantially pointed.

6. The post assembly of claim 1 wherein the first end of the post is provided with jagged teeth.

7. The post assembly of claim 1 wherein the post is provided with a channel extending from the first end to the second end of the post.

8. The post assembly of claim 7 wherein the channel is substantially v-shaped.

9. The post assembly of claim 1 wherein the driving member is provided with at least one cutout forming a tool.

10. The post assembly of claim 9 wherein the driving device surround the cutout forms a box style wrench.

11. The post assembly of claim 1 wherein the driving device is removably attached to the post in a stowed position when the driving device is not being used.

12. The post assembly of claim 1 wherein the driving device is removably attached to the post in a stabilizing position.

13. A method of driving a post into the ground, comprising the steps of:
providing a post having a first end and a second end;
positioning the first end of the post above the ground;
removably attaching a driving device to the post in a driving position; and
applying a force on a driving member of the driving device so as to drive the post in a downward direction into the ground.

14. The method of claim 13 wherein the post includes a plurality of pairs of spatially disposed holes positioned along the post, and wherein the method further comprises the steps of:
removably inserting a portion of the driving device into a pair of the spatially disposed holes;
applying force on the driving member of the driving device to drive the post into the ground;
detaching the driving device from the pair of spatially disposed holes;
removably inserting the portion of the driving device into another pair of spatially disposed holes positioned farther from the ground; and
applying force onto the driving member of the driving device to continue driving the post deeper into the ground.

15. The method of claim 13 further comprising the step of:
positioning the driving device on the post so as to prevent the post from going further into the ground.

16. The method of claim 13 further comprising the steps of:
attaching a second post to the post;
detaching the driving device from the post;
removably attaching the driving device to the second post;
applying a force to the driving member to drive the second post into the ground and drive the post further into the ground.

17. A marking device, comprising:
a plurality of posts wherein each post has a first end and a second end and wherein the plurality of posts is positioned in a tripod configuration; and
a cap having a plurality of legs connected to and extending from a connecting member such that each of the plurality of legs are connected to each of the plurality of posts and wherein the plurality of legs are selectively movable from the connecting member between an open position in which the legs are spread apart and a closed position in which the legs are adjacent one another.
